(19) United States
(12) Patent Application Publication
(10) Pub. No.: US 2021/0287306 A1
(43) Pub. Date: Sep. 16, 2021

(54) NETWORK AND PRODUCTIVITY PLATFORM FOR PODCASTS

(71) Applicant: Wildcast, Inc., La Jolla, CA (US)

(72) Inventors: Scott D. Pomerantz, Wyckoff, NJ (US); Madison Catania, La Jolla, CA (US)

(21) Appl. No.: 17/200,709

(22) Filed: Mar. 12, 2021

Related U.S. Application Data
(60) Provisional application No. 62/988,552, filed on Mar. 12, 2020.
(60) Provisional application No. 63/071,657, filed on Aug. 28, 2020.

(51) Int. Cl. G06Q 50/00; G06Q 10/10; G06Q 30/02

(52) U.S. Cl. CPC G06Q 50/01; G06Q 30/0275; G06Q 30/0264; G06Q 10/1095

(57) ABSTRACT

Methods and apparatus configured for use with a network and productivity platform for podcasts is provided. A method, for example, includes accessing a first information relating to at least one podcast and a second information relating to at least one guest, where the first information contains profile information regarding a podcast and the second information contains profile information regarding a prospective guest of the podcast; comparing the first information with the second information; generating results of a comparison of the first and second information that relates to a specific user; and connecting a specific podcast to a specific guest based on the results of the comparison.

### CROSS-REFERENCE TO RELATED APPLICATIONS

The present application claims the benefit of and priority to U.S. Provisional Patent Application Ser. No. 62/988,552, filed Mar. 12, 2020, and U.S. Provisional Patent Application Ser. No. 63/071,657, filed Aug. 28, 2020, the entire contents of each of these applications is incorporated herein by reference.

### BACKGROUND

### 1. Field of the Disclosure

Embodiments of the present disclosure generally relate to podcasts, and more particularly, to a network and productivity platform for podcasts, podcast guests, and third parties involved in the podcast industry.

### 2. Description of the Related Art

Podcasts are associated with really simple syndication (RSS) feeds which use a lightweight XML format. A podcast can be organized into episodes much like a radio or television program. Currently, there are approximately 850,000 active podcasts, though that number continues to grow daily.

Approximately 25% of podcasts have guests, which can, typically, be booked on a case-by-case basis. Guests can be booked through, for example, reliance of friends of friends, finding publicist and/or manager contacts, or using private messaging on social media platforms. Thereafter, a network or team representing the podcast host(s) (or the host themselves) coordinates with the guest or guest representatives to book the guest on the podcast. There are a number of factors involved when it comes to finalizing guest bookings. For example, some podcasts record in person only, while others allow remote interviews. Additionally, hosts may need to book studio time, for both in-person and remote recordings, while other hosts may invest in equipment for conducting or creating a podcast.

As can be appreciated, a guest booking process can be tedious, time consuming, and not cost effective. Thus, a network and productivity platform would prove useful in the podcast industry (e.g., for hosts, guests, third parties, and the like). Similarly, coordinating other aspects of podcast recording and publishing such as advertising and promotional trades with other podcasts, booking studio time, and coordinating with podcast editors, are time consuming and there is currently no streamlined method to make the process more efficient.

### SUMMARY

Embodiments of the invention comprise a network and productivity platform for podcasts that facilitates matching podcast hosts with podcasts guests.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a network diagram of an operating environment for a network and productivity platform for podcasts, in accordance with at least some embodiments of the present disclosure.

FIG. 2 is a detailed block diagram of the operating environment in which the network and productivity platform for podcasts operates, in accordance with at least some embodiments of the present disclosure.

FIG. 3 depicts a flow diagram of a method of operation of a website in accordance with at least some embodiments of the present disclosure.

FIG. 4 depicts a flow diagram of a method of operation of a matching engine in accordance with at least some embodiments of the present disclosure.

FIG. 5 depicts a flow diagram of a method of performing the matching process in accordance with at least some embodiments of the present disclosure.

FIGS. 6A-6T are diagrams of screen-shots, in accordance with at least some embodiments of the present disclosure.

### DETAILED DESCRIPTION

The methods and apparatus described herein provide a network and productivity platform for podcasts. The methods, for example, can include a host (or hosts) (or parties representing the host(s)) entering demographics and downloading information, which can be verified through a hosting platform (e.g., on a server, application/software and/or social media including Instagram®, Facebook®, Twitter®, Snapchat®, etc.), and specifying what type(s) of guests that the host is interested in booking. Similarly, a prospective guest (or guest representatives) can enter information on the network and productivity platform relating to an industry that the guest is associated with, guest followings, relevant guest experience, and the like. Additionally, guests can also indicate what types of interviews and/or podcasts that the guests are interested in participating in. The network and productivity platform can provide a list of relevant candidates for both the hosts and the guests to choose from, in addition to other novel features, as will be described in greater detail below.

The network and productivity platform can also be used as a scheduling tool. For example, podcasters (e.g., hosts) can enter their locations and availability to schedule recording time more efficiently, rather than an email chain, which can take (last) days or weeks. In at least some embodiments, studios can provide (publish) available studio times for a more streamlined booking process.

Moreover, podcasts often participate in ads or promotions with brands or other podcasts. For example, podcasts can trade space to promote another podcast in an episode (or several). In such instances, two or more intermediaries between the podcasters or the podcasters themselves can be involved in booking an ad trade, where typically, podcasts of similar sizes trade advertising space to promote the other podcast, likely for little to no cost. Accordingly, the network and productivity platform described herein allows podcasts to directly provide the necessary information on the network and productivity platform, thus providing podcasts with a simple and more cost-effective way to promote their podcasts on other podcasts.

The methods and apparatus described herein use the network and productivity platform which allows one or more users to connect with one or more other users based on at least one or more commonalities therebetween, e.g., based on interests, experience, popularity, and/or other relevant factors typically linked to the podcast industry. For example, in at least some embodiments, the network and productivity platform allows podcasters to connect with one or more guests and/or one or more other podcasters, to search for (or reserve) one or more studio locations, to search for (or hire) one or more editors, and/or to schedule recordings, thus providing improved quality content for podcast listeners and/or audiences. More particularly, unlike conventional podcast processes, which use one or more manual processes and are relatively time-consuming, the network and productivity platform described herein is partially or fully automated and allows podcasters to obtain and book well-suited talent in a relatively quick and efficient manner, thus maximizing the podcasters content. Additionally, the network and productivity platform described herein can be used to introduce third parties in the podcasting process, such as podcast studio locations and editors, thus further streamlining the podcast process.

In at least some embodiments, hosts/guests can be required to pay a subscription fee to use the network and productivity platform (e.g., monthly, annually, etc.). Conversely, in at least some embodiments, the hosts/guests would not be required to pay a subscription fee.

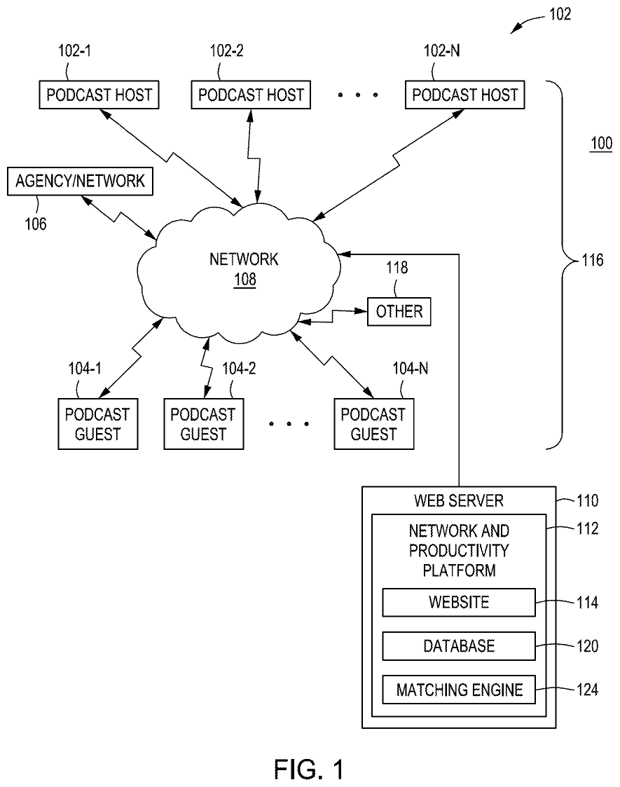

FIG. 1 is a network diagram of an operating environment 100 for a network and productivity platform 112, in accordance with some embodiments of the present disclosure. The operating environment 100 comprises a plurality of user devices 116 coupled to a network 108. The network 108 is coupled to a web server 110 that provides the network and productivity platform 112 via a website 114. The plurality of users 116 include a plurality of podcast hosts 102-1, 102-2, . . . 102-N (collectively podcast hosts 102) and a plurality of podcast guests 104-1, 104-2, . . . 104-N (collectively podcast guests 104). The term podcast host is intended to include the podcast entity (e.g., corporation, proprietorship, podcaster, etc.) as well as any person representing the podcast via the platform. Similarly, a podcast guest is intended to include any person or their representative that desires to be a guest of a podcast. In some instances herein, podcast and host are used interchangeably. In addition, the users 116 may include various podcast agencies/networks 106, where such agencies and networks comprise representative agents that represent a plurality of podcast hosts and/or podcast guests. Furthermore, the platform 112 may be used by other users 118 such as advertisers, service providers (i.e., studios, equipment sales, service or rental, audio engineering, etc.) and the like. The term user may include (but is not limited to) elements such as a computer, a personal digital assistant (PDA), a laptop or electronic notebook, a cellular telephone, an IP telephone, an iPhone®, an iPad®, a Microsoft Surfacer®, an Android® phone, a Google Nexus®, or any other device, component, element, or object capable of initiating data exchanges within the environment 100. A user may employ any device capable of operating as a user device to connect to communications network 108 via wire, wireless, cellular, satellite link or other suitable interfaces.

The communications network 108 is an electronics communications network operable to exchange data or information emanating from the users 116 and the web server 110. The communications network 108 represents an Internet architecture in a particular embodiment of the present disclosure, which provides the users 116 with the ability to electronically execute or to initiate user actions associated with the network and productivity platform 112. The communications network 108 may be, in part or in whole, a mobile phone (cellular) network, which the user 116 could use to perform the same operations or functions via, e.g., short message service (SMS) messages, multimedia messaging service (MMS) messages, etc. Such transactions may be assisted by management associated with the website 114 and/or manually keyed into a telephone or other suitable electronic equipment. The communications network 108 could be any packet data network (PDN) offering a communications interface. The communications network 108 may alternatively be any local area network (LAN), metropolitan area network (MAN), wide area network (WAN), wireless local area network (WLAN), virtual private network (VPN), intranet, internet or any other appropriate architecture or system that facilitates communications in a network or telephonic environment.

As shall be described in greater detail below, the web server 110 comprises a computer server that is operable to receive and to communicate information to the users 116. The web server 110 can implement a computer-implemented network and productivity platform 112 that provides a framework/platform for various podcast activities. Alternatively, the web server 110 may include any switch, router, gateway, cache, server blade, software, processor, proprietary component, object, module, or element (or any combination thereof) operable to facilitate communications involving the users 116. The web server 110 may be integrated with the database 120 and/or the website 114, where any one or more of these elements may share or otherwise coordinate the activities discussed herein.

In operation, the environment 100 supports the users 116 ability to interact with the webserver 110. As will be described in greater detail below, the users 116 utilize locally executing browsers (or apps) to access the platform 112 via the website 114. The website 114 provides an interface through which a user 116 may enter data (i.e., a profile) and have the profile stored in a database 120. Hosts 102, guests 104, agencies 106 and others 118 may interact with the platform 112 through webpages that are tailored to their specific requirements for each type of user. Once the various users have populated the database 120 with their information, a matching engine 124 matches hosts and guests. The engine 124 may also facilitate advertising assignments, advertising swaps, matching of advertisers to podcasts, recording scheduling, and the like.

The matching engine 124 generates recommendations based on matching information of hosts and guests. The webserver 110 transmits the recommendations as well as information about the recommended host and/or guest to the user 116 for display.

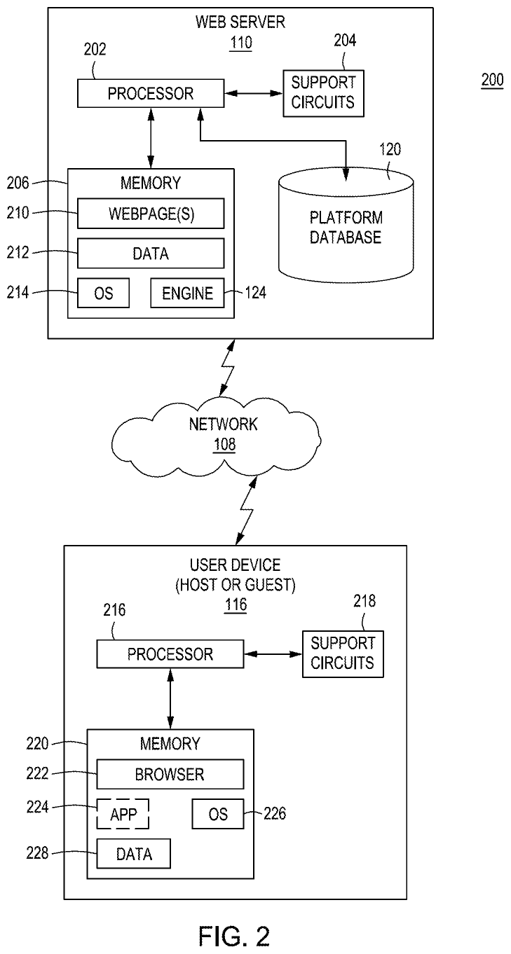

FIG. 2 is a detailed block diagram of the operating environment 100 in which the network and productivity platform for podcasts operates in accordance with at least some embodiments of the present disclosure. As broadly describe above, the environment 100 comprises a web server 110, a network 108 and a user device 116 (i.e., host, guest, agent, or others device). The web server 110 may be a general-purpose computer that is programed to become a specific purpose computer for operating to provide a network and productivity platform as described below. The web server 110 comprises a processor 202, support circuits 204, memory 206 and a platform database 120. The processor 202 may comprise, one or more or any combination of, microprocessors, microcontrollers, central processing units (CPUs), graphics processing units (GPUs), digital signal processors (DSPs), field programmable gate arrays (FPGAs), application specific integrated circuits (ASICs), or the like. The support circuits 204 comprise various circuits and devices to support the operation of the processor 202, including, but not limited to, clock circuits, cache memory, displays, power supplies, communications circuits, interfaces, and the like.

The memory 206 comprises a non-transitory computer readable storage medium such as read only memory, random access memory or a combination thereof (e.g., volatile and non-volatile memory). The memory 206 may store webpages 210, data 212, an operating system (OS) 214 and a matching engine 124. The webpages 210 together form the website 114 described above. The webpages 210, data 212 and the matching engine 124 shall be described in detail below. The operating system 214 may be any operating system used in a web server including, but not limited to, Apple OS X Server, Microsoft Windows Server, Linux, Solaris, and the like.

The web server 110 may comprise a platform database 120 for storing user data related to the network and productivity platform. The database may be part of memory 206 or may be a local or remote database for storing bulk data. The matching engine 124 accesses data from the database to perform the matching processes described below.

The user (or user device) 116 is an electronic device such as desktop computer, PC, mobile phone, laptop, server, cloud-based server, or other suitable computing device) that is configured to operate in a network environment 100 and provide an interface through which a user may interact with the platform. The user device 116 may be a general-purpose computer that is programed to become a specific purpose computer for providing an interface to the network and productivity platform. The user device 116 comprises a processor 216, support circuits 218, and memory 220. The processor 216 may comprise, one or more or any combination of, microprocessors, microcontrollers, central processing units (CPUs), graphics processing units (GPUs), digital signal processors (DSPs), field programmable gate arrays (FPGAs), application specific integrated circuits (ASICs), or the like. The support circuits 218 comprise various circuits and devices to support the operation of the processor 216, including, but not limited to, clock circuits, cache memory, displays, power supplies, communications circuits, interfaces, and the like.

The memory 220 comprises a non-transitory computer readable storage medium such as read only memory, random access memory or a combination thereof (e.g., volatile and non-volatile memory). The memory 220 may store browser 222, data 228, and an operating system (OS) 226. The browser 222 may be any type of browser that facilitates access to a website (e.g., website 114). The operating system 226 may be any operating system used in a user device including, but not limited to, Apple iOS, Microsoft Windows, Linux, Google Android, and the like.

In lieu of or in addition to a browser, the user device memory 220 may store an optional application (app) that provides an interface to the platform without using webpages as an interface. When the processor 216 executes such an app, the app forms the interface to the platform and data flows to and from the user device 116 via the app connection to the web server 110. Functionality of such app-based embodiments are the same as described below with respect to the website-based interface.

Operation of the network and productivity platform will be described herein in terms of a method for matching a host (podcaster) and a guest with each other as well as providing various support services to the podcasting community. For illustrative purposes, the network and productivity platform is assumed to be accessed via the web server 110 using one or more of the above-described users 116. In addition to matching, the network and productivity platform provides guest and podcast networking, podcast advertising trades and podcast host swaps, advertiser bidding for podcasts, advertiser collaborations with guests, and project management tools for podcasters, podcast guests, and sponsors.

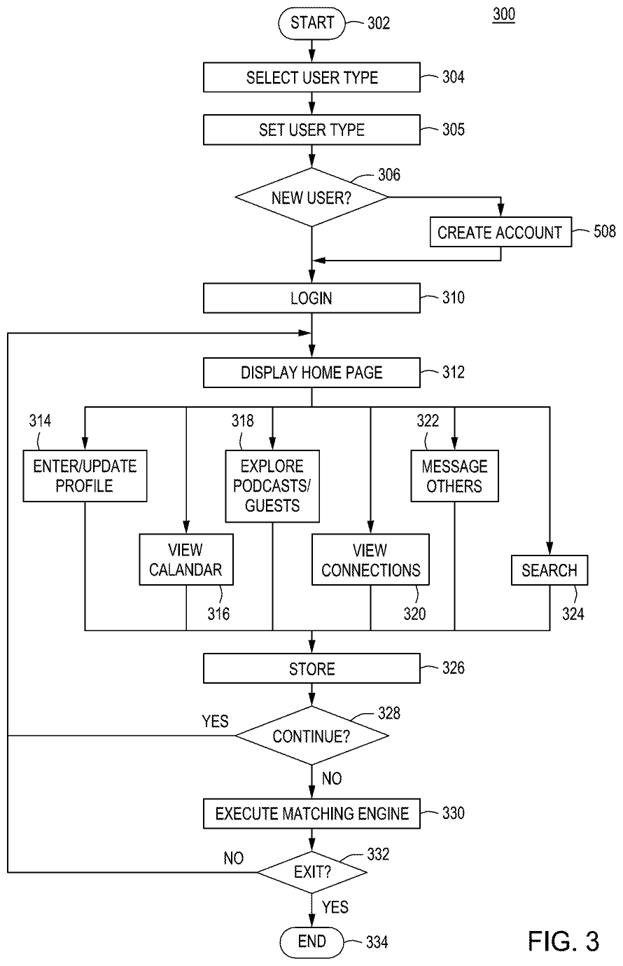

FIG. 3 depicts a flow diagram of a method 300 of operation of the website (114 in FIG. 1) in accordance with at least some embodiments of the present disclosure. The method 300 starts arts 302 and proceeds to 304 where the user is queried about the type of user, i.e., whether the user is a guest, podcast (host), agency or network. At 305, the type the is selected is set and depending on the selection, a different home page will be launched for each user type. At 306, the user is queried whether the user is a new user. If a new user, the method proceeds from 306 to 308 where the user creates a new account and then proceeds to 310 to login. If the user has an account, the method proceeds from 306 to 310 to enable the user to login. Once logged in, at 312, the method 300 displays the home page for the user. If the user is a new user, the home page will currently have no content.

Each home page for each user type (as shall be described below in greater detail with respect to the images of home pages) has several selectable functions. From the home page, a user may enter (new user) or update (prior user) their profile 314, review a calendar for scheduling interviews 316, explore podcasts or guests 318, view connections to podcasts or guests 320, message other platform users 322, and globally search the database of user data 324. Each of these functions (options) are described in more detail below. In general, guests enter profile data that describes themselves, their backgrounds and their capabilities regarding past podcasts in which they have been involved and podcasts upon which they wish to be a guest, podcasts enter profile data regarding the podcast, the host(s) of the podcast and the type of guests that are preferred, and an agency or network (agent representative thereof) enters the profile data of a number of podcasts or guests that they represent. At 326, any data entered is stored in the platform database (120 of FIG. 1). At 328, the method 300 queries whether the user desires to continue. This is generally not a hard query but results when a user selects a different function from a function selection bar statically displayed on a portion of the webpage (e.g., in a function bar). In this manner, the user may display any of the pages related to home or any of the functions available to that user's type (i.e., guest, podcast, agency or network).

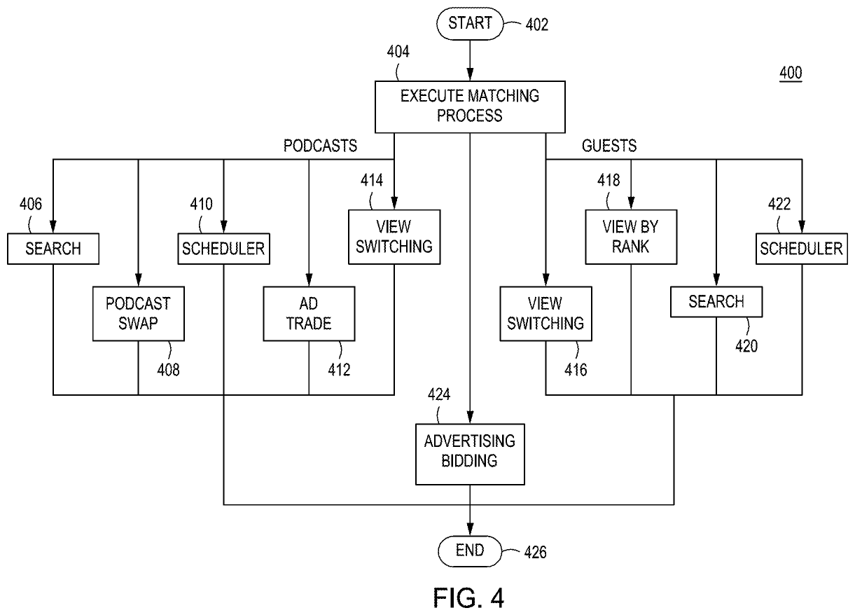

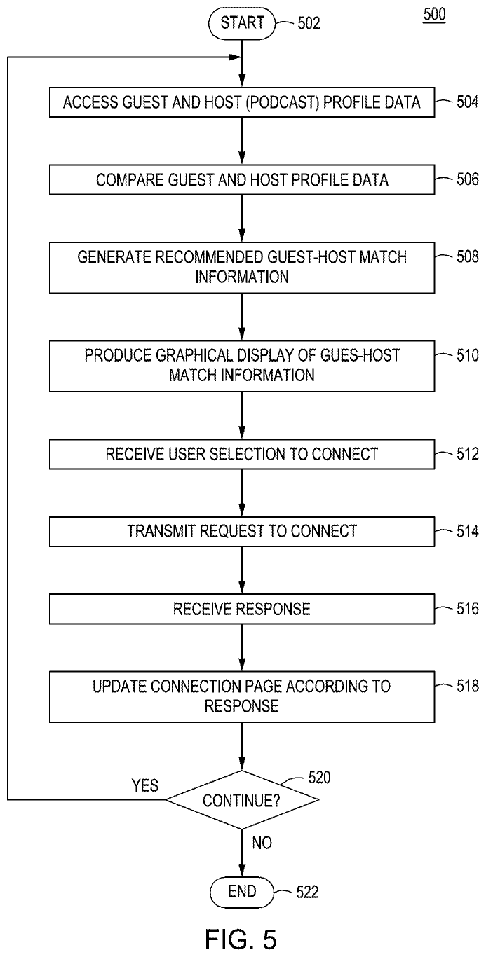

At 330, the method 300 executes the matching engine (124 in FIG. 1). Although the execution of the matching engine is shown for convenience as a step in a process, the matching engine function generally operates in the background at all times and is continuously performing the matching engine function on all new data available to the platform. The matching engine is described in detail with reference to FIGS. 4 and 5 below.

At 332, the user is queried whether they desire to exit. Generally, this function is not a formal query, but rather the user selecting to end the session by either moving away from the website, specifically electing to log out, or inactivity for a pre-defined period. Depending on the indication of whether exit is warranted, the method 300 either continues to the home page or another function or ends at 334.

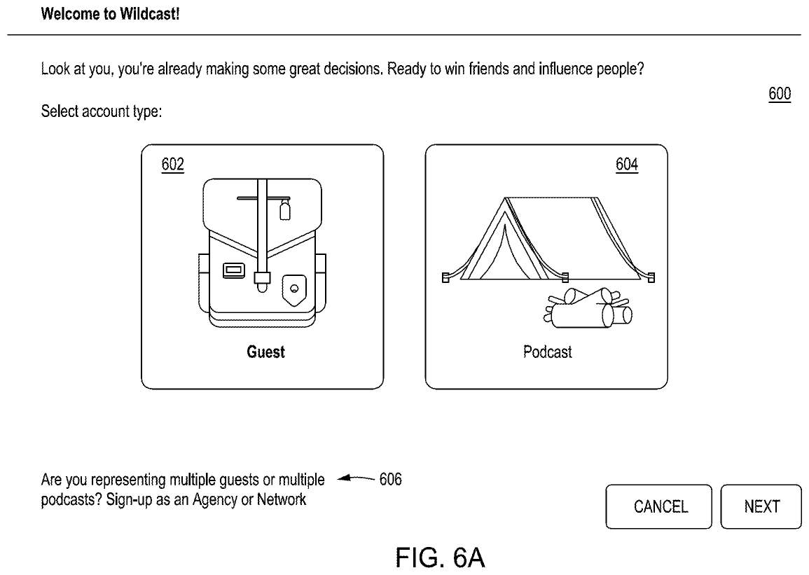

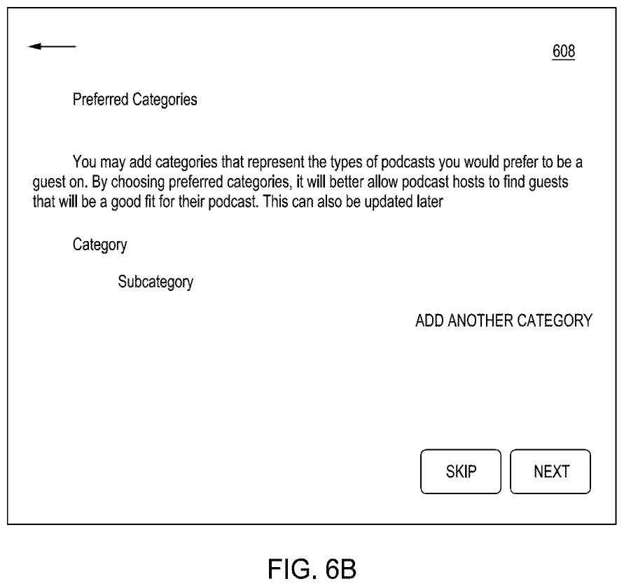

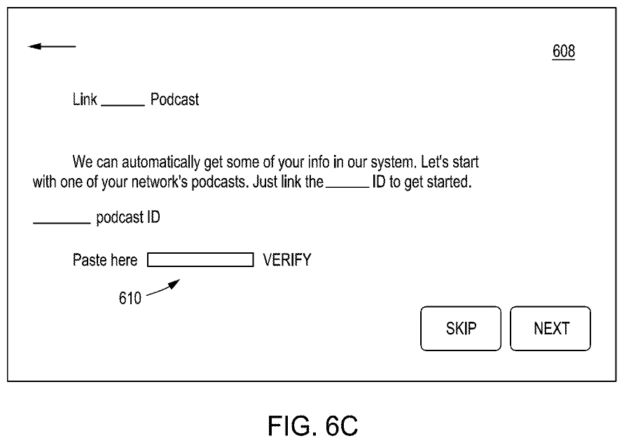

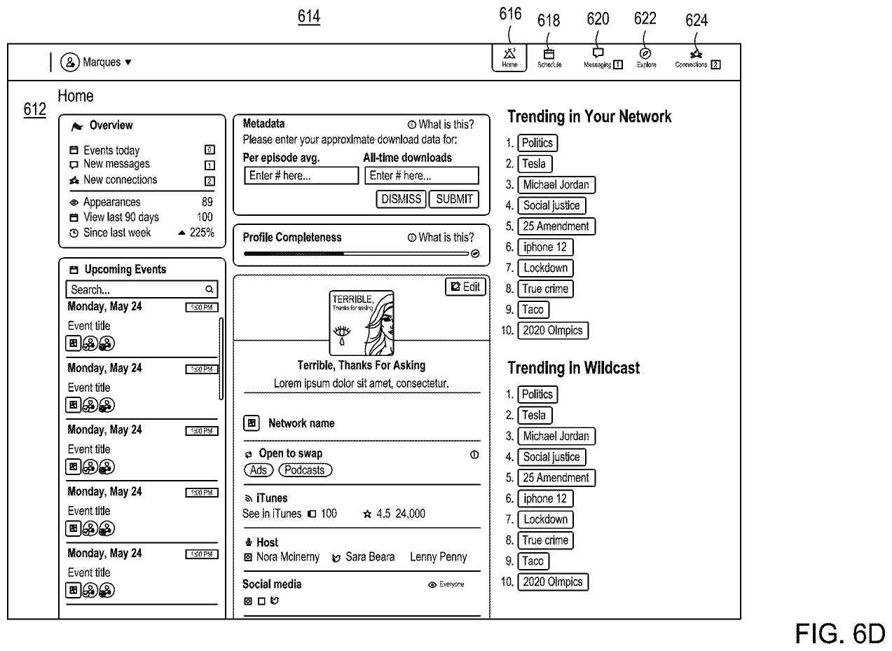

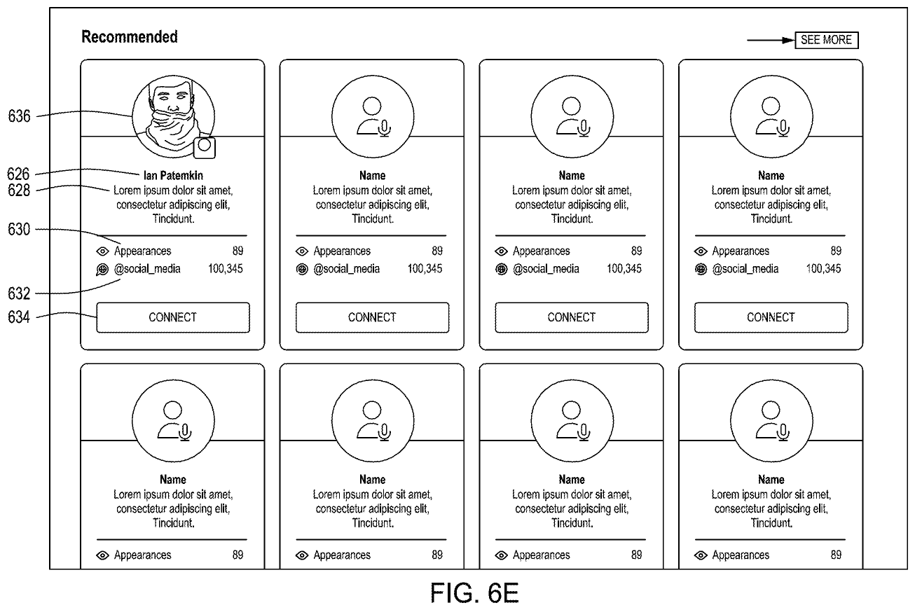

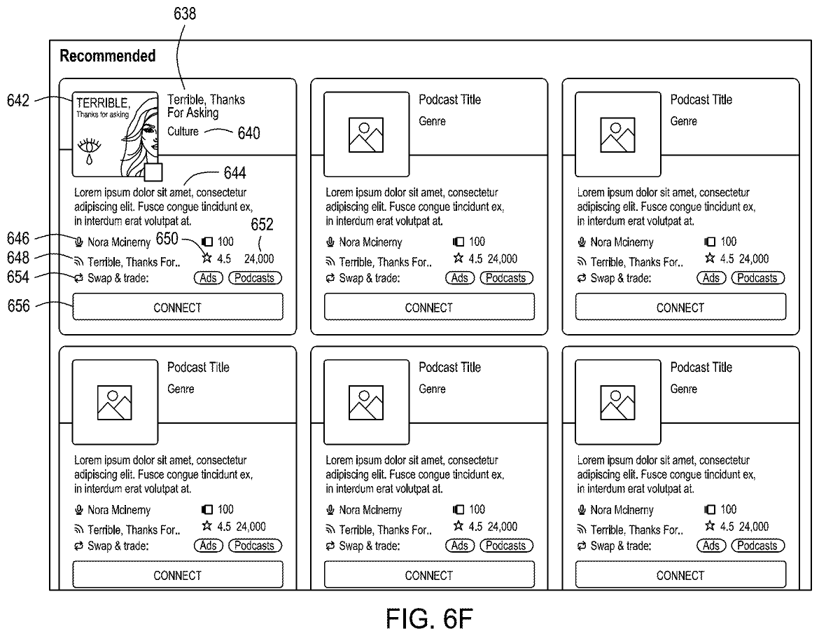

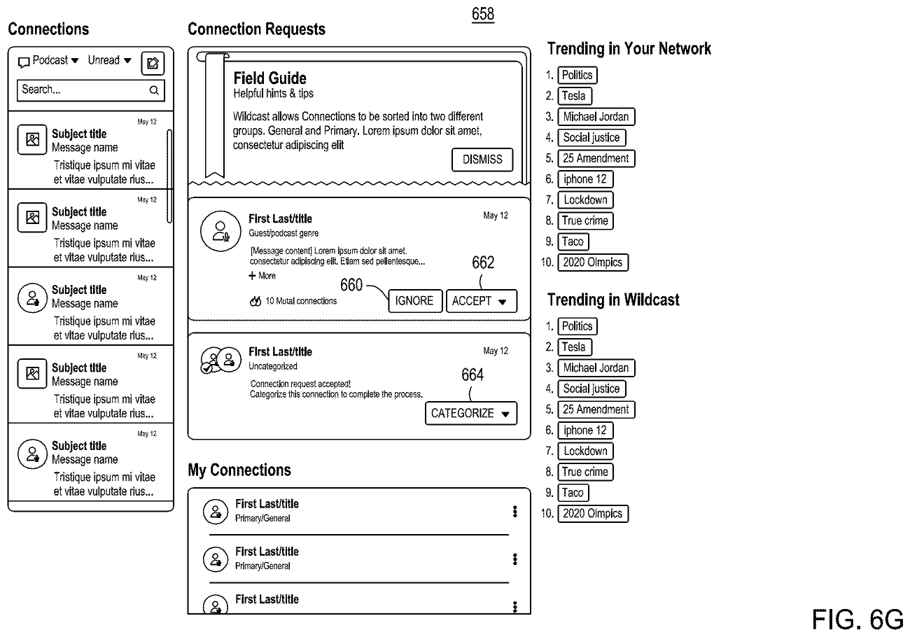

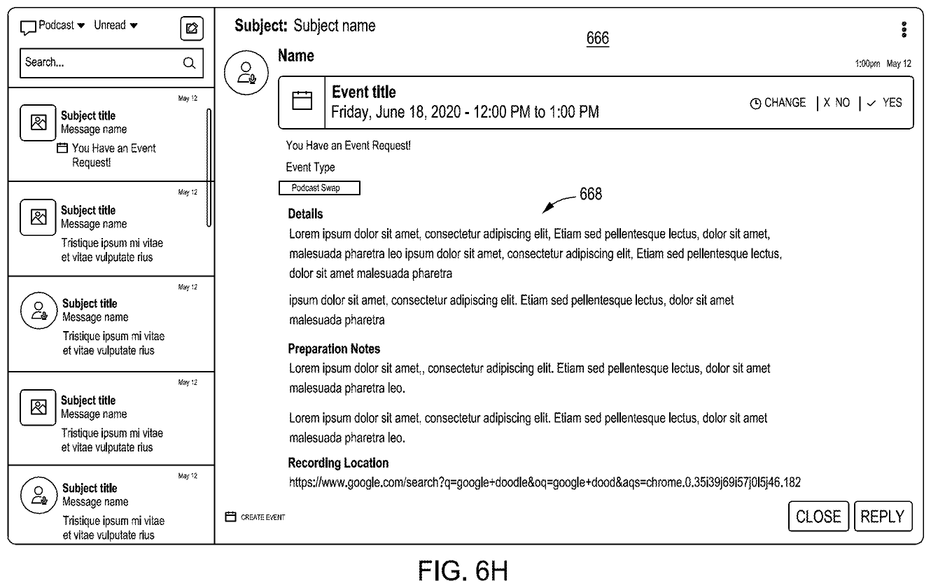

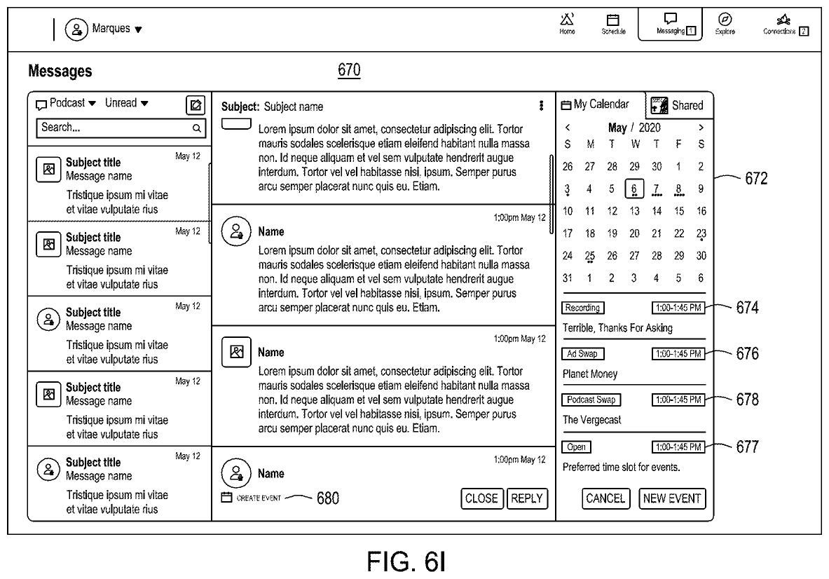

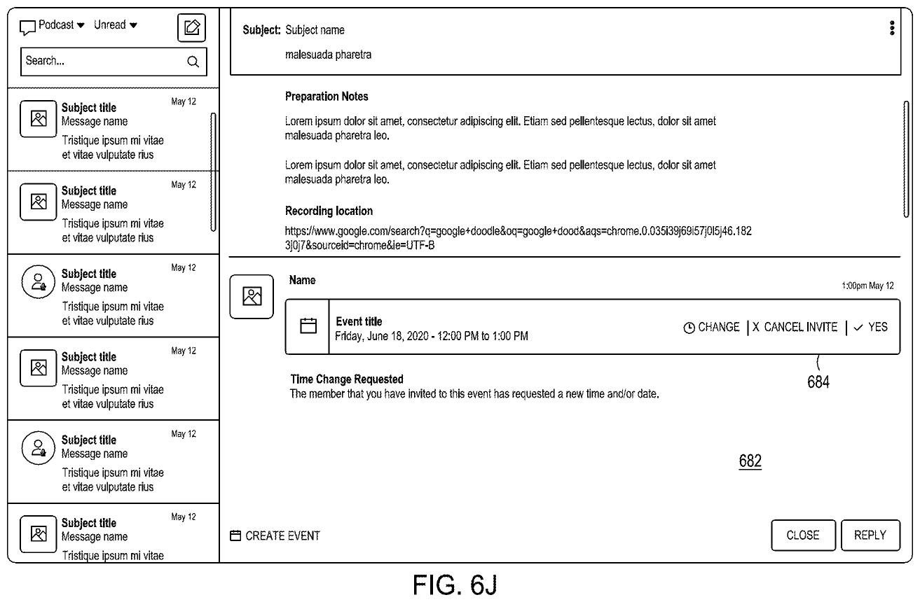

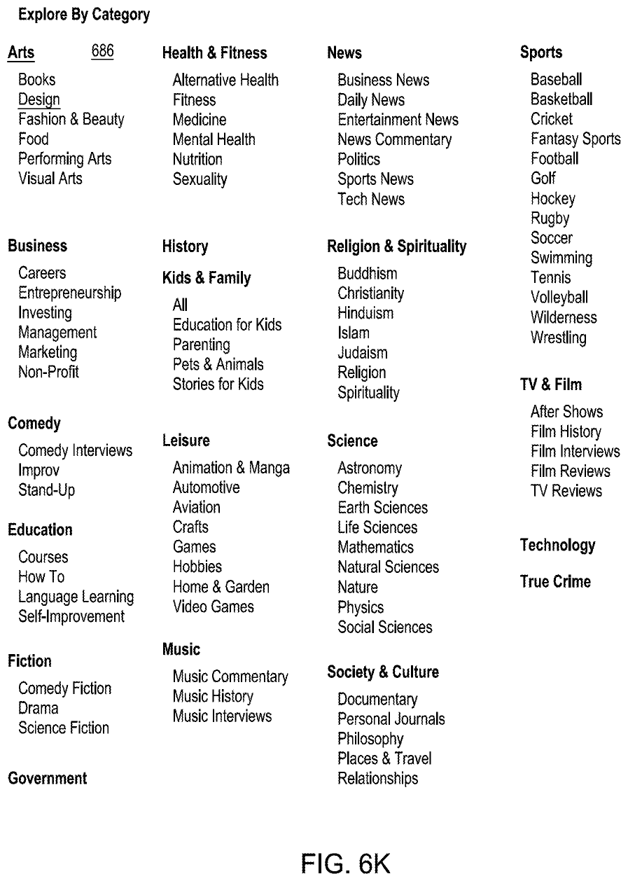

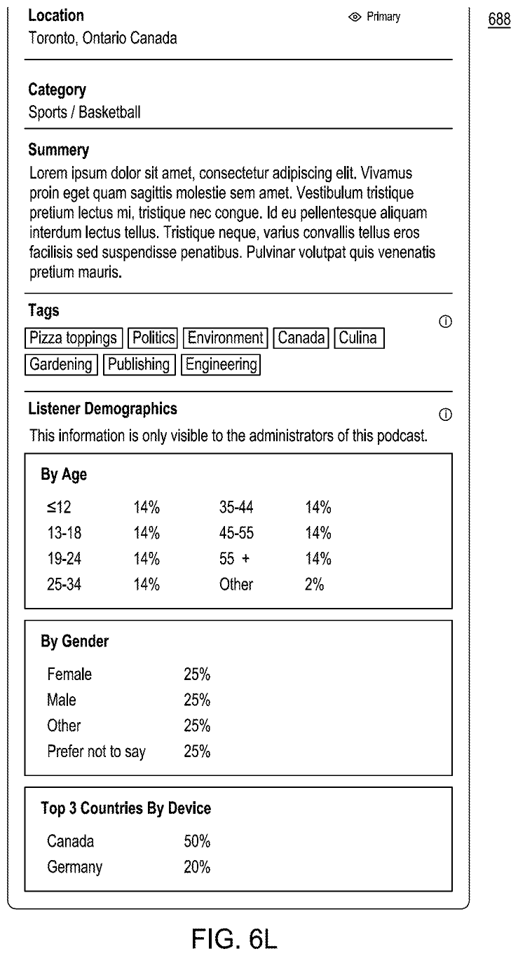

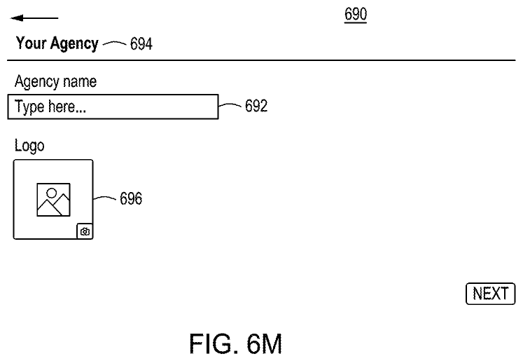

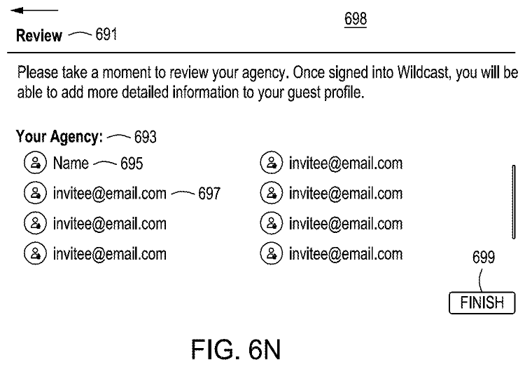

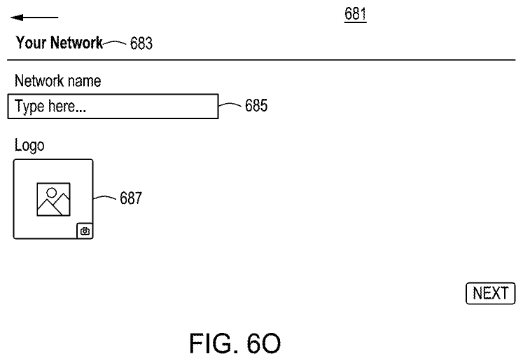

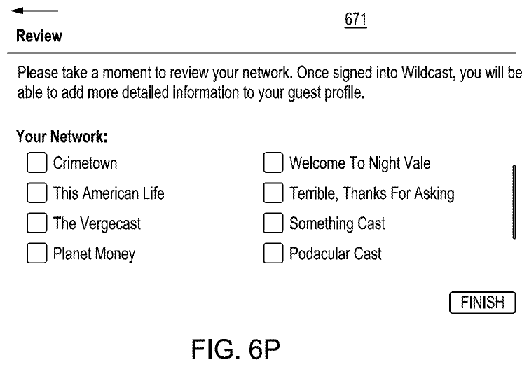

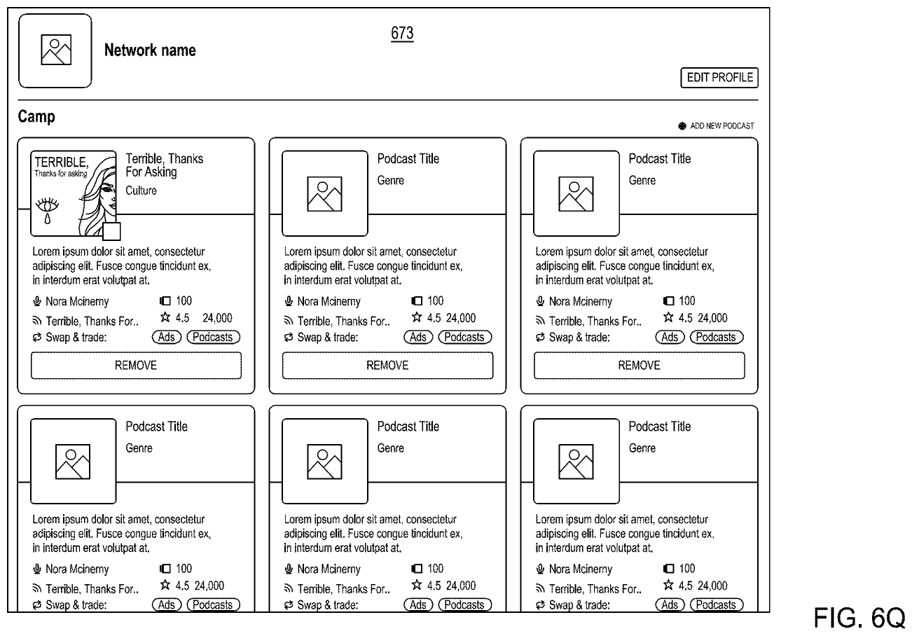

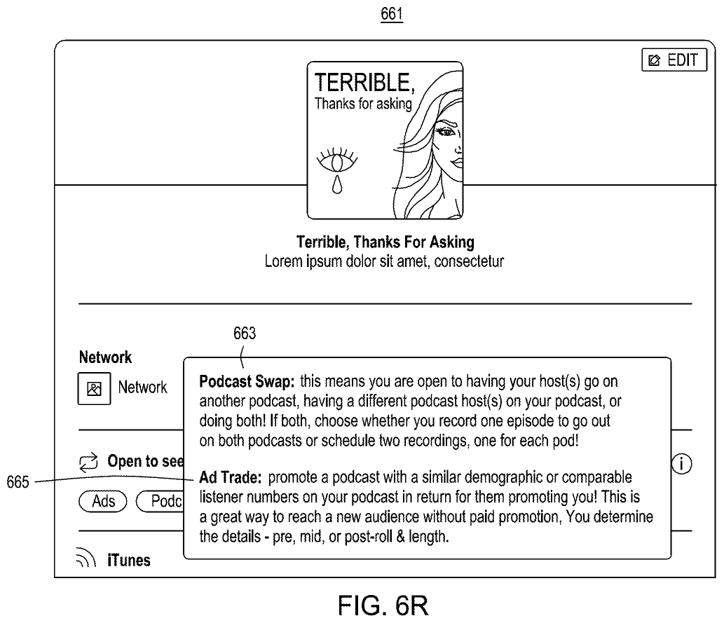

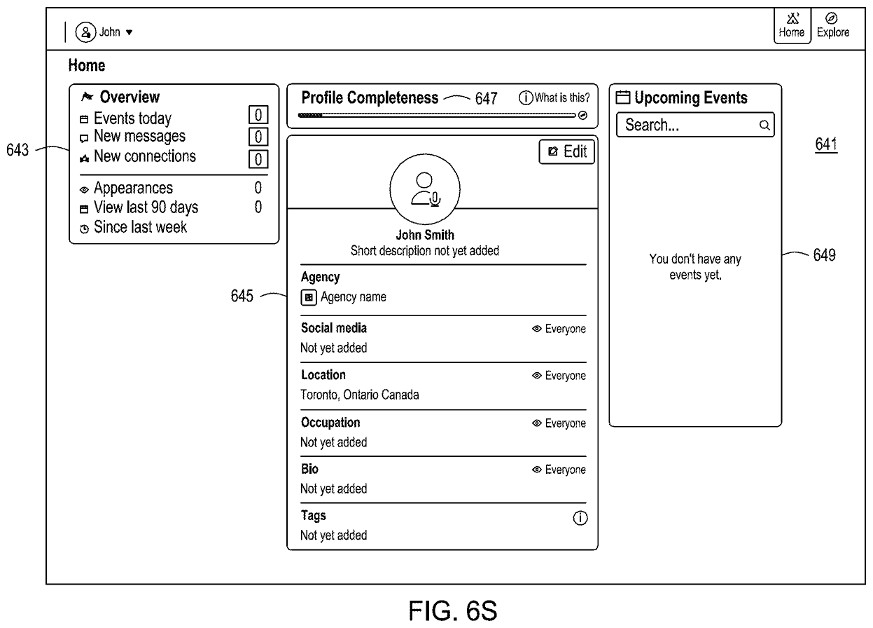

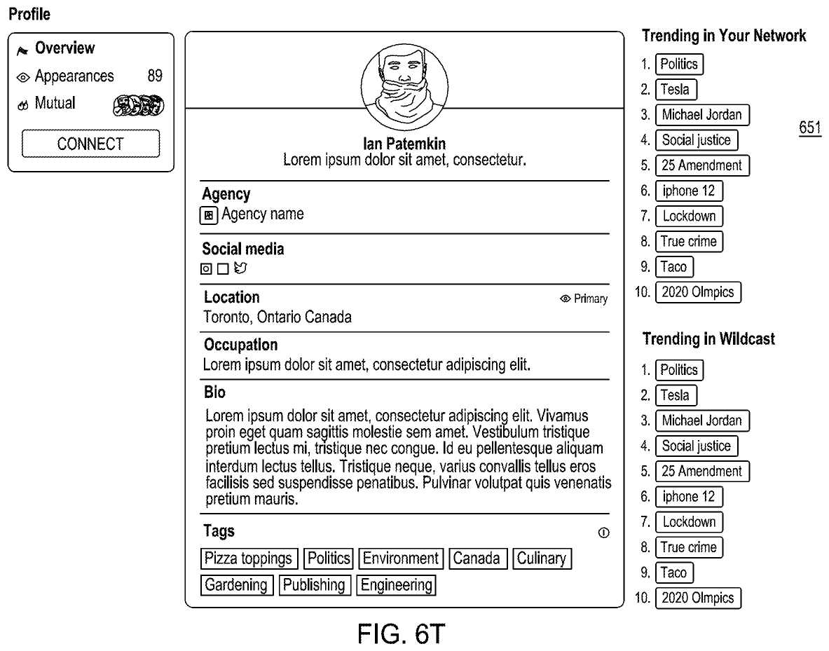

FIG. 4 depicts a flow diagram of a method 400 of operation of the matching engine (124 in FIG. 1) in accordance with at least some embodiments of the present disclosure. The matching engine is for matching users of the network and productivity platform such that hosts and guests are matched in accordance with their user profiles. The method begins at 400 and proceeds to 402 where a matching process is executed. The matching process (described in detail with respect to FIG. 5) processes the guest profile data (a first information) and podcast (host) profile data (a second information) to create recommended matches between guests and podcasts. The podcast and/or the guest has an opportunity to connect or not to connect with the recommended user. Once connected, several post-match functions are available to podcasts, guests, and advertisers. Each of these functions is summarized below and described in more detail with respect to the screen shots in FIGS. 6A-6T.

For podcasts, at 406, more advanced searching can be performed on the narrowed list of recommended guests. At 408, podcasts may elect to swap hosts and/or co-host a program—a feature known as Podcast Swap. At 410, podcasts may offer to promote other podcasts on their podcast—a feature known as Ad Trade. Podcasts can be matched for promotional swapping based on rank, demographic, audience size and so on. As such, a podcast can promote itself to a broader audience without incurring additional advertising costs. At 414, a user may view switch such that their user as a podcast may switch to show other podcasts rather than the matched guests. Such view switching facilitates finding and reviewing podcasts that may be compatible for podcast swap or ad trading. Being able to view other podcasts also facilitates communication between podcasts via the messaging function that is built into the platform. At 412, the scheduler may be invoked to enable a podcast to schedule an interview on a particular guest.

For guests, at 418, podcasts may be viewed in a ranked hierarchy based on audience size, regional reach and so on. At 420, advanced searching may be performed to further narrow a list of recommended podcasts. At 422, the scheduler may be invoked to enable a guest to schedule an interview on a particular podcast. At 416, view switching may be selected to enable a guest to view other guests and communicate with them through the messaging feature that is built into the platform.

Lastly, at 424, third party advertiser may offer advertising to podcasts. Embodiments of the network and productivity platform allow brands and sponsors to join the network and productivity platform to 1) bid on ads and inventory within podcasts and/or 2) contact guests for possible brand collaborations and paid advertisements. For example, an ad agency/sponsor can bid for advertisement time during a podcast. The bid amount can be, for example, for a time slot during a podcast. For example, an agent/agency can bid for a time slot for a podcast, and the bid amount can be based on how far in advance the bid is made before the podcast. A podcast can allow sponsors/agents to bid on advertising inventory starting at a minimum specified bid. In some instances, the sponsors/agents can purchase rather than bid on the spot if the podcast specifies a “buy now” price: for example, begin bidding at $500 or buy now at $2000. This will apply to unsold podcast advertisement inventory or inventory that podcasts choose to sell within the platform. Ad agencies, sponsors, and/or brands can also choose to contact guests on the network and productivity platform if the Ad agencies, sponsors, and/or brands are interested in potentially working with that guest for a paid sponsorship (e.g., a social media promotion).

Accordingly, in at least some embodiments, the method can include receiving a bid on at least one of an advertisement or inventory for a time slot during a podcast. For example, in at least some embodiments, an agency can tender a bid, via for example a message, to a host of a podcast for advertisement time during the podcast. The bid for at least one of an advertisement or inventory for a time slot can be performed (rendered) during a podcast. Alternatively or additionally, the bid on the at least one of the ad or inventory can be performed prior to a podcast and based on a time when the bid is received relative to a podcast start time.

The method 400 ends at 426.

FIG. 5 depicts a flow diagram of a method 500 of performing the matching process in accordance with at least some embodiments of the present disclosure. The matching process may be an ongoing background process that handles new data as the data is entered, or the process may execute when a user selects the “explore” function and a set of recommended guests or podcasts are displayed. For a given user, their particular recommendations can be updated upon login or profile update.

The method 500 begins at 502 and proceeds to 504 where the method 500 accesses guest and podcast data, i.e., the profile data previously entered regarding guests and podcasts. At 506, the guest profile data (a first information) and host profile data (a second information) are compared to find matches. The criteria for matching may be weighted by field of information. The weighting may be static or dynamic to create prioritization of the data fields. Those prioritizations may be different for different types of podcasts and guests based on topic category, audience size, number of hosts, number of guests, and so on. Artificial intelligence, or machine learning, may be used to adjust the weighting to learn and improve matching results.

At 508, as a result of the comparison performed at 508, the method 500 generates prospective guest to host (podcast) match information (e.g., recommended podcasts that match the guest's profile or vice versa). At 510, the method 500 produces a graphical display of the rerecommended guest-host match information. For guests, the recommended podcasts are displayed and, for hosts/podcasts, the recommended guests are displayed. The graphical display presents the user with selectable fields enabling a user to select at least one recommended podcast or guest that they wish to be connected.

At 512, the method receives a user selection to connect to a particular recommended podcast. At 514, the method 500 transmits a request to connect to the selected user. At 516, the method 500 receives the user's response to the request. The user may ignore or accept the request to connect. In other embodiments, a user may have the option of rejecting the request. At 518, the method 500 updates the connections page accordingly, i.e., to display the newly connected guests or podcasts that accepted the request to connect. At 520, the method 500 decides to continue the matching process or end. If the method 500 continues, it returns to 504. Otherwise, the method 500 ends at 522.

FIGS. 6A-6T are diagrams of screen-shoots displayed on one or more user devices 116 of FIG. 1 in which the network and productivity platform can be accessed via the web server 110. In at least some embodiments, the network productivity can also be embodied as application software and installed on the user devices 116 of FIG. 1 to provide a similar interactivity experience as describe with respect to the website 114.

FIG. 6A is a diagram of an onboard screen 600 (welcome screen) that can be displayed and used to allow a user, e.g., a guest, host, an agent/agency, and/or a network, to enter (e.g., sign in, login, or register to) the network and productivity platform. For example, the onboard screen 600 allows a user to enter as a guest 600 and/or a podcast 602 (e.g., a host), both a host and a guest, or a representative signing up on behalf of a host and/or a guest. Additionally, the onboard screen provides a link 606 for an agent/agency and/or network to sign up, e.g., if multiple guests/podcasts are being represented by an agent representative. In at least some embodiments, for example, if a user is a host and/or a guest, the user can select connecting with guests and/or connecting with other hosts (podcasters). Once an option is selected, a user can click next to continue with the onboard process. Additionally, once selected the identification (ID) information can be saved. In at least some embodiments, a verification email (or other suitable method, e.g., text, instant messaging, and the like) can be sent to the user.

In at least some embodiments, the onboard screen 600 (or another screen) can include one or more graphical user interfaces (pop-ups) requesting that a user to create a username and password. Additionally, an additional welcome screen (not explicitly shown) can be displayed for users that have previously signed up and are returning to the network and productivity platform. The additional welcome screen can be configured similarly to the onboard screen 600 of FIG. 6A), with one or more modifications being provided.

In at least some embodiments, after a user has registered (or logged on), a user may provide additional information. For example, FIG. 6B shows a screen shot 608 of a screen that allows a user to enter preferred categories (sub-categories) that represent the types of podcasts the user may be interested in participating in. Next, a screen can be provided to a user to allow a user to enter a name thereof, e.g., name of the guest and/or the host.

Additionally, in at least some embodiments, a user can be provided with a screen (e.g., screen shot 608 of FIG. 6C) that includes one or more areas 610 that can be used to paste a link (e.g., a network podcast) to automatically retrieve and save information of the user, which helps streamline the registration process.

A user may be provided with the ability to input profile information to build/develop a profile of the user. The profile information, for example, may include a picture (or other image), such as cover art, host(s) names, guest names, podcast name, a brief biography of the host, one or more PDFs, tags and/or other categories that may be applicable at the time of building the profile. For example, the profile can include, for a host name, a category of a podcast (new to the network and productivity platform, as seen on TV, medical mavens, our favorite experts, featured, bingeworthy, recommended based on browsing, featured, comedy (host), financial, sports, current events, etc.). Additionally, the profile information can allow host to enter/select a type of guest that the host is potentially interested in interviewing, e.g., reality star, mommy blogger, etc. Moreover, the profile information allows a host to enter/select (share) respective locations and enter/select whether the host is able to conduct remote interviews (e.g., via phone, skype, etc.). The network and productivity platform allows a host to specify keywords and/or tags, and locations (when not able to conduct remote interviews).

For example, FIG. 6D is a diagram of a screen shot of a top home dashboard screen 612 that can indicate an overview area listing events, messages, connections (e.g., new connections), appearances, views and a time frame of the views (e.g., last week, last month, etc.). Additionally, the top home dashboard can include an upcoming events area including a search area and listing found podcasts including dates, times, titles, and other relevant information. A metadata area that allows a user to enter various metadata, such as, per episode average, all-time downloads and profile completeness area that indicates a completeness of a profile can also be included on the top home dashboard screen. The top home dashboard screen can also be configured to allow a user to edit profile information, such as, network information, open to swap, RSS information, host information, social media information, etc. Trending tags can also be displayed in the top home dashboard screen.

In at least some embodiments, the information provided in FIG. 6D can also include information relating to ranking podcasts and/or hosts (and/or guests), based on, for example, statistics and/or download numbers (e.g., 50,000-100,000 downloads per episode), popularity of the podcast and/or host, several reviews and/or other suitable indicators. Having the capability of ranking a podcast and/or host is advantageous, such as when there are a multitude of podcasts and/or hosts subscribed to (stored on) the network and productivity platform, in that guests can easily sort through the rankings when searching for a podcast and/or host, as opposed to merely searching a particular category. In at least some embodiments, the rankings of the podcasts and/or hosts can be updated automatically and/or manually. For example, in the former instance, the network and productivity platform can be linked to one or more podcast platforms and can automatically retrieve the desired ranking information.

For example, the network and productivity platform allows hosts to search for guests based on one or more criteria, which can include, for example, a number of followers on social media that follow a guest, a number of times a guest has been on a podcast, fields/occupations, locations for interviews, dates of a podcast, availability, etc. Such information can be inputted manually and updated manually and/or automatically. The network and productivity platform also allows hosts to perform a more specific search for guests. For example, the more specific search can be based a specific type of guest, e.g., reality star, movie star, not a medical professional, broadcaster, etc., and a specific location (e.g., Los Angeles, New York City, etc.) and/or time zone (e.g., pacific, eastern, central, etc.). In addition, the search for guest screen can also provide an option to save the search criteria.

For example, as noted above, in at least some embodiments, the network and productivity platform is configured to rank podcasts, e.g., based on statistics and/or download numbers (e.g., 50,000-100,000 downloads per episode), popularity of the podcast and/or host, a number of reviews and/or other suitable indicators. Accordingly, in at least some embodiments, the processor can provide a guest with a searching for podcasts screen that includes, in addition to options for a category, location, and specific search, an option for a browse by rank can be provided to a guest to further filter or limit a podcast search.

In at least some embodiments, after a user has registered or developed their profile, the user can explore (connect) with other users. For example, in at least some embodiments, a user can select one or more icons that are provided on a navigation bar 614. In at least some embodiments, the one or more icons of the navigation bar 614 can include a home icon 616, a schedule icon 618 (e.g., calendar selectable option), a messaging icon 620 (e.g., messaging selectable option), an explore icon 622 (e.g., explore selectable option), and a connections icon 624 (e.g., connection selectable option). The connection icon 624 allows the user to view previously selected connections, the messaging icon 620 allows the user to view messages, the schedule icon 618 allows the user to view upcoming scheduled events or a calendar, and the explore icon 622 allows the user to navigate through the podcast information or the guest information.

Accordingly, after a user selects, for example, the explore icon 622, the network and productivity platform compares the user information (e.g., a host's information) with user information (e.g., a guest's information) stored at the server, i.e., performs the matching process.

Once the matching process is complete, when the user is a host of a podcast, a list of recommendations of guests that match the host's information (criteria) is generated. Likewise, when the user is a guest wanting to participate on a podcast, a list of recommendations of podcasts that match the guests' information (criteria) is generated.

The recommended guest-host information is displayed to the user in the form of a plurality of selectable options. For example, when the user is a host wanting a guest to participate (appear) on a podcast, the host is provided with a list of recommendations of guest that match the host's information (criteria), as shown in FIG. 6E. Likewise, when the user is a guest wanting to participate on a podcast, the user is provided with a list of recommendations of podcasts that match the guests' information (criteria) as shown in FIG. 6F.

As illustrated in FIG. 6E, each listed guest can include, for example, a guest name 626, brief description of the guest's credentials 628, number of appearances of the guest 630, social media followers 632, a connect option 634, a photo 636, etc. Similarly, in FIG. 6F, each of the listed podcasts can include a podcast title 638, a podcast genre 640, an image area representative of the podcast 642, a brief description of the podcast 644, a host name of the podcast 646, an RSS area 648, a rating of the podcast 650, followers or viewers/listeners of the podcast 652, a swap and trade option 654, e.g., for ads and podcasts, and a connect option 656.

The user may then make a selection from the user device of one of the plurality of selectable options. For example, in at least some embodiments, a user can select the connect option 634 or the connect option 656 for the when the user is a host of a podcast or guest, respectively. Once a “connect” selection is made, a request to connect is sent to a target user. The target user is provided an opportunity to respond to the request.

FIG. 6G is a diagram of a screen shot of connections screen 658. The connections screen 658 includes an ignore area 660, accept area 662, or categorize area 664 that allows the user to respond to the connection request accordingly. The connections screen 658 can also allow a user to group the connections into two or more groups, e.g., general and primary. Listed connections may include an area for a first and last name, primary, general, an area that indicates if a connection is a guest, podcast, a podcast genre, message content area, an area indicating mutual connections, and. The connections screen can provide a “my connections area” that lists the connections and an area that lists “tags” that are trending in your network or trending in the network and productivity platform. In another embodiment, a rejection area may be used to allow a user to specifically and unequivocally reject a connection request.

FIGS. 6H and 6I are diagrams of screen shots of portions of a messaging screen that allows a user to receive/read messages, e.g., relating to podcasts and guests. For example, a messaging screen 666 (FIG. 6H) can include a listing of received event request messages 668. The listing of the received event messages 668 can include a subject/event title, message name, date, a brief description of the message/event/podcast, etc. Clicking on a received message allows a user to view the contents of the message. For example, the message screen 666 can list a name of a connection, event/podcast title, an indication that an event has been requested, event type, e.g., podcast, swap, etc. details of the event, preparation notes, recording location of the event including a link associated therewith, a create event option, and a close/reply option. Similarly, a messaging screen 670 (FIG. 6I) can list a subject name of a received message, a name of a connection, an updatable calendar 672 that lists recording times 674, Ad swap times 676, and podcast swap times 678, a create event icon 680, an open time slot icon 677 for events, etc.

FIG. 6J is a diagram of a screen shot of a reply messaging screen 682 that allows a user to reply to the event request message 668. The reply messaging screen 682 is substantially similar to the message screen 666 and the message screen 670, but also includes a time change request area 684 that allows a user to request a new time and date in the reply message.

FIG. 6K is a diagram of a screen shot of an explore category search screen 686 that allows a user to search for podcasts by one or more categories. For example, in at least some embodiments, the one or more categories can include art, business, comedy, education, fiction, health and fitness, history, kids and family, leisure, music, news, religion and spirituality, science, society and culture, sports, TV and film, technology, true crime, and the like. Each of the one or more categories can be broken down into sub-categories. For example, the comedy category can be broken down into comedy interviews, improv and stand-up sub-categories. The granularity of the sub-categories can be modified based on, for example, the type of category, user preference, etc. A user can access the explore category search screen 686 by selecting the explore icon 622 from the navigation bar 614.

FIG. 6L is a diagram of a screen shot of a bottom home dashboard screen 688 that can show user information and allow users to specify who they would like to be able to view that information (i.e., none, everyone, general connections, primary connects). The bottom home dashboard screen 688 includes a location, category, a summary of the podcast, one or more various tags, e.g., pizza topping, politics, environment, etc., and podcast listener demographics, e.g., percentage of podcast listeners within certain age groups, gender, and top countries that the podcast reaches.

FIG. 6M is a diagram of a screen shot of a screen 690 that can be used by a user such as an agent/agency (e.g., that which represents multiple guests) and can include an area 692 for inputting an agent/agency name, an area 694 for the agent/agency name, and an area 696 for the agent logo, which can be uploaded using known processes. The information can be used by an agent/agency to connect with relevant podcasts for their guests.

After the information of FIG. 6M is inputted, a review screen 698 of FIG. 6N can be displayed. The review screen 698 can be used to review the information described with respect to FIG. 6M. For example, the screen of FIG. 6N can include a review area 691 including an agent/agency name 693, a name of an agent/agency 695, one or more invitees 697 including respective photos and emails, and a finish tab 299 that can be used to store the information after a review of the information is complete. The invitees can be, for example, agency team members and/or the guests themselves.

FIG. 6O is a diagram of a network screen 681 that allows a user (e.g., guest, host, agency) to enter network information into the network and productivity platform. The network screen 681 can include an area for the network 683, an area 685 to input the network name, and an area 687 for an image associated with the network, e.g., a logo. Once the information is inputted, a user can select next to review the network information. FIG. 6P is a diagram of a screen shot of a network screen 671 that lists podcasts of a selected network, thus allowing a user to confirm that the podcasts of the network are correct. If not, a user can manually remove/add podcasts as required. A user can select finish when completed. FIG. 6Q is a diagram of a screen shot of a network edit screen 673 that allows a user to edit a selected podcast and/or remove/add podcasts as required.

FIG. 6R is a diagram of a screen shot of an ad trade/swap screen 661. The podcast swap portion 663 of the ad trade/swap screen 661 allows podcasters to swap podcast hosts with each other or trade advertising spots. The podcast swap portion also allows a podcast host to choose whether to record one episode to go out on both podcasts or two episodes, one for each podcast. The ad trade portion 665 of the ad trade/swap screen 661 allows a podcaster to promote (e.g., during pre, mid, or post-roll and length of an ad) a podcast of a different podcaster, e.g., podcasts having similar demographic and/or comparable listener numbers. The ad trade option allows podcasters to reach out to new audiences, without paid promotion.

FIGS. 6S and 6T are diagrams of screen shots of a profile dashboard screen 641 and a profile view screen 651, respectively. The profile dashboard screen 641 includes an overview area 643 that lists events, messages, new connections, appearances, number of views within a predefined time frame, etc. A profile area 645, which can be edited as needed, can be provided and displays an image of a user, an agent/agency name (if any), associated social media, location, occupation biography, tags, etc. A profile completeness area 647 can be provided and can be configured to indicate a completeness of the information provided in the profile area. Additionally, an upcoming events area 649 can be provided and configured to allow a user to search for upcoming events and list found upcoming events. The profile view screen 651 allows a user to view a selected profile of a user and provides the profile information of FIG. 6Q. Additionally, the profile view screen 651 can also include the above-described trending information.

In addition to the foregoing, the network and productivity platform allows hosts, podcasters, guests, agents/agencies to build social and professional networks within the network and productivity platform to utilize and reference on an ongoing basis.

In at least some embodiments, the network and productivity platform can provide a user with the ability to toggle between a guest view and podcast view, e.g., when a user is both a host and a guest. Additionally, the network and productivity platform can provide a user with the ability to toggle between host-to-host view and host to guest view, e.g., when a user is interested in connecting with both other hosts and/or guests. Moreover, the network and productivity platform can provide a user with the ability to toggle between three different views (e.g., host to host, host view, and guest view) for users who are hosts interested in booking guests and other hosts and interested in being a guest (a combination of the above two scenarios).

In addition to the foregoing, the network and productivity platform can provide post-match functions. For example, as shown in FIG. 6O, the network and productivity platform provides a host and/or guest with the ability to send a messages, request availability, or to cancel/confirm interviews. Other options can also be provided on the screen shown in FIG. 6P, such as options for upcoming recordings, which can be shown under an upcoming recordings folder, options for a host/guest to select available/partially available/unavailable dates, and locations where the host/guest will be on such dates, and/or budget restraints.

The network and productivity platform can be configured to allow third parties (other than a host or a guest) to input information. For example, in at least some embodiments podcast (or other type of) studios (e.g., remote and/or local) can input calendars and rates for one or more booking scenarios, such as: a podcast and guest recording in person and need studio space; a podcast is recording with a remote guest that needs to record in studio (e.g., for better sound quality); the podcast host is recording remotely with the guest but does not have proper setup (e.g., host/guest are traveling); and two or more podcasts are recording together remotely and need separate podcast studios.

The network and productivity platform can also be configured to provide post-recording functionality. For example, after a host and guest have successfully recorded together, the network and productivity platform stores and can provide a list of past recordings, thus enabling a host and/or guest to retrieve stored recordings, e.g., for re-bookings.

Moreover, the network and productivity platform can also be configured to provide freelance podcast editors with the ability to input availability and rates should a host require editing a podcast, e.g., for last minute changes.

In at least some embodiments, the network productivity platform can also be configured to automatically schedule a recording for a host and a guest even if there is no indication/selection of mutual interest there between. Similarly, the network productivity platform can also be configured to automatically set up swaps/trades between two or more hosts (or a third parties) even if there is no indication/selection of mutual interest therebetween.

In at least some embodiments, the network productivity platform can also be configured to provide a host (podcaster) with the ability to search for another host (podcaster), e.g., host to host option. For example, when a host (podcast) is interested in connecting with other hosts (podcasts), a host can select one or more search options that apply to a host search criteria. For example, in at least some embodiments, the search options can include: a) podcast swap/trade or joint recording, e.g., the two podcasts can record a joint episode that both hosts can release, or the hosts can serve as “guests” on each other's podcasts; b) ad trade, e.g., the hosts' podcasts can include ads for each other in a specified upcoming episodes, either for free or a negotiated rate (e.g., if one podcast is more popular than the other podcast, the less popular podcast may pay a fee). In such an instance, a host-to-host screen may include a fee payment option, Apple Cash, Venmo, link to one or more financial institutions, etc.; and c) mentorship or general networking, e.g., host (podcast) may want to connect with other hosts for technical or marketing support, or just to chat and/or connect with others in the podcast industry.

Here multiple examples have been given to illustrate various features and are not intended to be so limiting. Any one or more of the features may not be limited to the particular examples or embodiments presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e. within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g. one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

While the foregoing is directed to embodiments of the present disclosure, other and further embodiments of the disclosure may be devised without departing from the basic scope thereof, and the scope thereof is determined by the claims that follow.

What is claimed is:

1. A method of matching users of a network and productivity platform for podcasts, the method comprising:
accessing, at a server, a first information relating to at least one podcast and a second information relating to at least one guest, where the first information contains profile information regarding a podcast and the second information contains profile information regarding a prospective guest of the podcast;
comparing, at the server, the first information with the second information;
generating, at the server, results of a comparison of the first and second information that relates to a specific user; and
connecting a specific podcast to a specific guest based on the results of the comparison.

2. The method of claim 1 wherein the connecting further comprises:
transmitting, to a user device, a plurality of selectable guest or podcast recommendations based on the results of a comparison;
receiving a selection from the user device of one of the plurality of selectable guest or podcast recommendations;
receiving a request from the user for connecting the user with another user, where the user and another user represent either a podcast or a guest; and
transmitting the request to the another user.

3. The method of claim 2, wherein transmitting comprises transmitting at least one a podcast title, a podcast genre, an image area representative of a podcast, a brief description of a podcast, a host name of a podcast, a really simple syndication (RSS) area, a rating of a podcast, followers or viewers/listeners of the podcast, or a swap and trade option.

4. The method of claim 3, wherein the swap and trade option allows users to swap podcast hosts with each other and trade advertising time slots, respectively.

5. The method of claim 1, further comprising transmitting a home page generated based on the information relating to a user, wherein the home page provides at least one of: an explore selectable option that allows the user to navigate through the first information or the second information, a connection selectable option that allows the user to view previously selected connections, a messaging selectable option that allows the user to view messages, or a calendar selectable option that allows the user to view upcoming scheduled events or a calendar.

6. The method of claim 1, further comprising receiving a bid on at least one of an advertisement or inventory for a time slot during a podcast.

7. The method of claim 6, wherein receiving the bid on the at least one of the advertisement or inventory is performed during a podcast.

8. The method of claim 6, wherein receiving the bid on the at least one of the ad or inventory is performed prior to a podcast and based on a time when the bid is received relative to a podcast start time.

9. A non-transitory computer readable storage medium having stored thereon instructions that when executed by a processor performs a method of matching users of a network and productivity platform for podcasts, the method comprising:
accessing, at a server, a first information relating to at least one podcast and a second information relating to at least one guest, where the first information contains profile information regarding a podcast and the second information contains profile information regarding a prospective guest of the podcast;
comparing, at the server, the first information with the second information;
generating, at the server, results of a comparison of the first and second information that relates to a specific user; and
connecting a specific podcast to a specific guest based on the results of the comparison.

10. The non-transitory computer readable storage medium of claim 9, further comprising:
transmitting, to a user device, a plurality of selectable guest or podcast recommendations based on the results of a comparison;
receiving a selection from the user device of one of the plurality of selectable guest or podcast recommendations;
receiving a request from the user for connecting the user with another user, where the user and another user represent either a podcast or a guest; and
transmitting the request to the another user.

11. The non-transitory computer readable storage medium of claim 10, wherein transmitting comprises transmitting at least one a podcast title, a podcast genre, an image area representative of a podcast, a brief description of a podcast, a host name of a podcast, a really simple syndication (RSS) area, a rating of a podcast, followers or viewers/listeners of the podcast, or a swap and trade option.

12. The non-transitory computer readable storage medium of claim 11, wherein the swap and trade option allows users to swap podcast hosts with each other and trade advertising time slots, respectively.

13. The non-transitory computer readable storage medium of claim 9, further comprising transmitting a home page generated based on the information relating to a user, wherein the home page provides at least one of an explore selectable option that allows the user to navigate through the first information or the second information, a connection selectable option that allows the user to view previously selected connections, a messaging selectable option that allows the user to view messages, or a calendar selectable option that allows the user to view upcoming scheduled events or a calendar.

14. The non-transitory computer readable storage medium of claim 9, further comprising receiving a bid on at least one of an advertisement or inventory for a time slot during a podcast.

15. The non-transitory computer readable storage medium of claim 14, wherein receiving the bid on the at least one of the advertisement or inventory is performed during a podcast.

16. The non-transitory computer readable storage medium of claim 14, wherein receiving the bid on the at least one of the ad or inventory is performed prior to a podcast and based on a time when the bid is received relative to a podcast start time.

17. An apparatus configured for use with a network and productivity platform for podcasts, the apparatus comprising:
a server configured to:
accessing a first information relating to at least one podcast and a second information relating to at least one guest, where the first information contains profile information regarding a podcast and the second information contains profile information regarding a prospective guest of the podcast;
comparing the first information with the second information;
generating results of a comparison of the first and second information that relates to a specific user; and
connecting a specific podcast to a specific guest based on the results of the comparison.

18. The apparatus of claim 17, wherein the server is further configured to transmit a home page generated based on the information relating to a user, wherein the home page provides at least one of an explore selectable option that allows the user to navigate through the podcast information or the guest information, a connection selectable option that allows the user to view previously selected connections, a messaging selectable option that allows the user to view messages, or a calendar selectable option that allows the user to view upcoming scheduled events or a calendar.

19. The apparatus of claim 17, further comprising receiving a bid on at least one of an advertisement or inventory for a time slot during a podcast.

20. The apparatus of claim 19, wherein receiving the bid on the at least one of the ad or inventory is performed during a podcast.
